(19) United States
(12) Patent Application Publication
(10) Pub. No.: US 2001/0054963 A1
(43) Pub. Date: Dec. 27, 2001

(54) Driving aid

(75) Inventor: Chun-Kong Cheung, Kowloon (HK)

Correspondence Address: JACOBSON HOLMAN PLLC, 400 SEVENTH STREET N.W., SUITE 600, WASHINGTON, DC, 20004, US

(73) Assignee: GEE (HK) Company Limited

(21) Appl. No.: 09/938,587

(22) Filed: Aug. 27, 2001

Related U.S. Application Data
(63) Continuation of application No. 09/136,890, filed on Aug. 19, 1998.

(51) Int. Cl. G08B 23/00

(52) U.S. Cl. 340/575; 340/573.1

(57) ABSTRACT

This invention provides a driving aid to assist in detecting when a driver may become drowsy while at the wheel of a vehicle. The device is fitted to a user's head and sounds an audible alarm or similar alarm indicator once the angular displacement of the device exceeds a set level. The device relies on a tendency of a driver's head to move downwardly as the driver becomes drowsy causing angular displacement of the device. Adjustment of the threshold angular displacement for activation of the alarm and adjustment of the time interval for which the angular displacement must be exceeded to trigger the alarm can be provided. The driving aid may also have an attachment which enables a user to place the device on an ear and/or hang on the frame of arm of a pair of glasses.

### BACKGROUND TO THE INVENTION

1. Field of the Invention

This invention relates to a driving aid and, in particular, although not necessarily solely, an aid to assist a driver and alert a driver when the driver begins to fall asleep at the wheel of a vehicle,

2. Description of the Prior Art

The driving of motor vehicles has become an ever increasing part of the livelihood of many people throughout the world. Numerous measures have been employed to try and reduce the accident rate caused by driver error including measures to regulate speeds, reduce alcohol consumption prior to driving and improve intersection control systems and roadways.

Despite all these measures, accidents still occur and some of these can be attributed to drivers falling asleep at the wheel of their vehicle. This can be particularly apparent in the case of drivers that regularly travel long distances such as those working in the transport industry or travelling salesman. Further, the driver that is not used to driving long distances may be required to attempt this at times and might be caught out by the fatigue which driving can cause.

To alleviate some of the problems associated with the potential drivers falling asleep at the wheel, various roading authorities have sought to design roads to reduce the monotony of driving long distances. Furthermore, various education campaigns have been run to trying encourage drivers to reduce the length of tide behind the wheel. This includes regulations for long haul transport drivers.

Regardless, such accidents continue to occur and there is little that can easily be done to a vehicle to counter this risk.

### OBJECT OF THE INVENTION

Therefore, it is an object of the present invention to provide a driving aid which may alert to driver should they have fallen asleep or otherwise be distracted from the roadway for a period of time. As a minimum, it is an object to the present invention to provide a driving aid which will overcome some of the disadvantages of the prior art or provide the public with the useful choice.

### SUMMARY OF THE INVENTION

Accordingly, the invention consists in a driving aid comprising:

-a movable portion movable between a first position and, upon inclination over a preset angle from the horizontal, to a second position;

-means to detect the movement of said movable object to said second position;

-means to alert a user when said movable object is in said second position for at least a preset time interval; and

-means to fit said driving aid to the head of a user.

Further aspects of this invention may become apparent to those skilled in the art to which the invention relates upon reading the following description.

### BRIEF DESCRIPTION OF THE DRAWINGS

The invention will now be described with reference to particular embodiments and with reference to the following drawings in which:

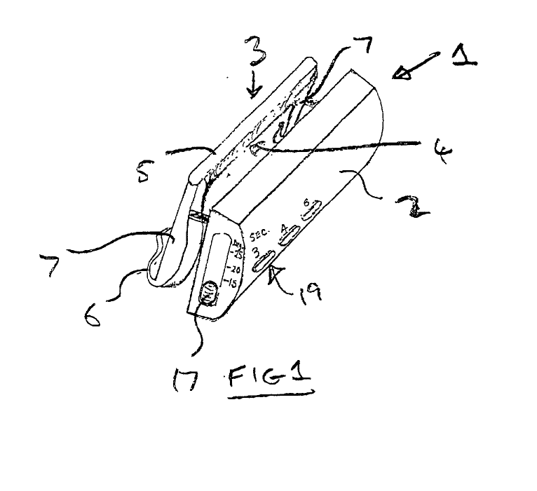

-FIG. 1 is a perspective view of at least one embodiment of the apparatus;

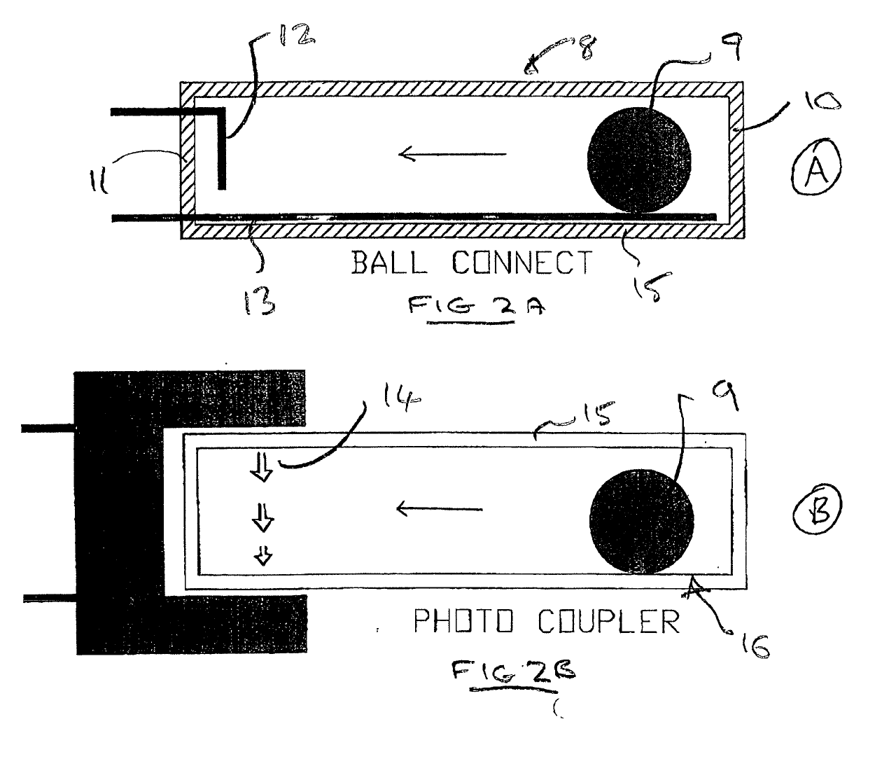

-FIG. 2A is a cross sectional view through a possible portion of the apparatus of FIG. 1;

-FIG. 2B is a cross section of view through an alternative portion to the portion shown in FIG. 2A; and

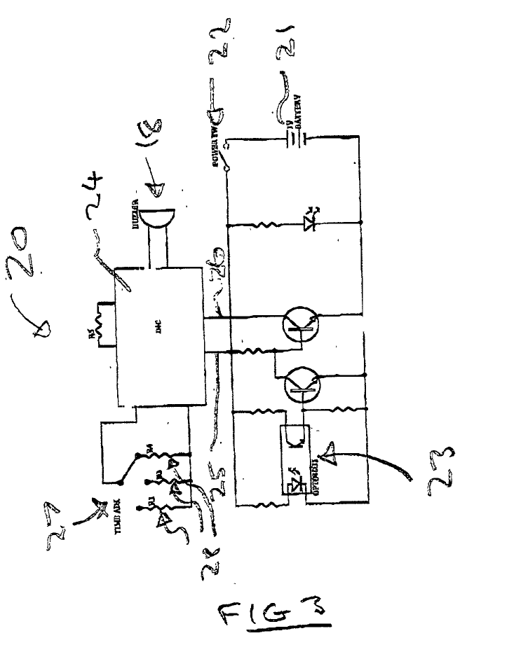

-FIG. 3 is a schematic diagram of a circuit for use within an embodiment of the apparatus.

### DETAILED DESCRIPTION OF PREFERRED EMBODIMENTS

This invention will now be described with reference to particular embodiments. Referring to the drawings, a first embodiment can be seen to comprise a driving aid 1 as shown.

The driving aid 1 may comprise an outer housing to which contains the major portions of the apparatus. This housing 2 may be connected to an attachment means 3 for attachment of the device to the head of a user.

As can be seen in FIG. 1, the attachment means 3 may comprise a shaped portion for fitment around the ear of a user hang an opening 4 in which the ear may sit with an upper portion 5 resting against an upper portion of the ear. In this preferred form, the means 3 for fitment to the user comprises both a potion 4 which accommodates the ear of a user as well as an alternative fitment means being glasses attachment means 6. This preferred form provides these as clips on downwardly depending portions 7 from the upper portion 5. These clips can clip around the arm of a pair of glasses to conveniently attach the device to the glasses rather than to the ear itself.

Of course, alternative means could be use to fit the device onto or adjacent a head of the user. As the device is design to detect angular displacement of the users head, it is preferred that this device be fitted in a substantially sale position with respect to the user's head.

Within the housing 2, means are provided to detect angular displacement of the device 2. As shown in FIG. 2, these may comprise devices such as a contact device 8 as shown in FIG. 2A. The device 8 contains a movable portion 9 which is movable between the fit position adjacent first end 10 of the device 8 and the second position in which the movable object 9 is adjacent a further end 11 of the device 8. Contacting means 12 and 13 can be provided to sense the movable object 9 being in the second position. In combination, these contacts act as a sensing means.

Although the preferred embodiments use sensors to detect the object in the second position, they can equally detect the absence of the object from the first position instead. It is a detection of the state of the object which is required to reflect the level of inclination of a user's head.

The sensing means can comprise a variety of types also. In this FIG. 2A, the sensing means comprises a simple pair of electrical contacts 12 and 13 for which a complete circuit is provided when the movable object 9 is in a second position. This assumes that movable object 9 is made from a conductive material to trigger the circuit. It is only in the second position that current can pass between contacts 12 and 13 through the movable portion 9.

Referring to FIG. 2B, a different sensing arrangement is provided. In this instance, some form of beam 14 is provided across the device which may be blocked by the movable object 9 when moving to the second position. Such a photo sensor or similar sensor can again provide an electrical signal to complete a circuit and to act as a switching means as well as a sensing means.

In both FIGS. 2A and 2B, the movable object 9 is shown as a substantially spherical object which will simply move from the first end 10 to a second end 11 within a conduit 15. Although this is one of the arrangements, other arrangements can also be used. The movable object may be of a different shape provided it moves smoothly when angular displacement occurs and the conduit 15 may simply comprise a base portion or guide or track 16 on which the movable object 9 may travel. There is no need for an entire enclosure as long as the device 8 provides the movable object 9 an adequate moving distance between first and second positions and indicates a particular angular displacement to reach the second position. In the preferred form, an enclosure is provided so that a moisture free environment exists in which the movable object resides.

Of course, simple fitment of such a device within the housing 2 where that the base portion guide or track 16 is substantially horizontal when fitted to the user would cause the angular displacement sensor to be triggered relatively frequently and perhaps too frequently for practical use. Therefore, it may be desirable to preset a threshold angle or incorporate angular displacement adjustment means to allow some adjustment to the angular displacement at which the alarm circuit would trigger. This may comprise a user input 17 to select a particular angle at which the alarm circuit would be triggered. Movement of this selector 17 may incline the base 16 so that the movable portion 9 is biased towards the first end 10. By raising the second end 11 or otherwise inclining the base 16 against movement of the movable portion 9 from a first position to a second position, the preset angular displacement level at which the alarm circuit would be triggered can be adjusted. This adjustment can accommodate different users tendencies to move the head while driving.

In addition to the sensing means, the device also employs some indicator 18 to alert the user to the inclined state of the device. The device is intended to be used to alert the driver should the driver become drowsy at the wheel and, therefore, some form of indicator such as an audible alarm may be suitable and is utilized in this preferred embodiment. Other indicators which may cause a driver becoming drowsy -to pay attention may be used in substitution of the audible alarm, such as vibration, etc.

In addition to an adjustment means for the angular displacement of the device, an adjustment may be provided to the time interval for which the threshold angular displacement needs to be exceeded for the device to trigger. Again, in this preferred form, such an adjustment may be selected by the user through a user interface 19. This interface 19 is provided for this embodiment in the form of buttons which select the number of seconds which the threshold angular displacement must be exceeded for the audible alarm to trigger.

Turning to FIG. 3, a possible circuit diagram is shown for inclusion within a device.

The circuit 20 can comprise a power source 21 and a simple on/off switch for times when the device is not in use.

The device 8 for detecting the angular displacement of the apparatus by means of a photo sensor is shown in FIG. 2B in this particular circuit design. This is generally shown as item 23 in the circuit diagram. Regardless of its type, the item 23 can be used as the inclination sensor to provide a signal to a control board 24 when the inclination of the device exceeds the pre-set level. The control board 24 is in the form of an integrated circuit or similar. This receives inputs by means of copper circuit 25 and 26 indicating the status of the sensor 23 when the power switch 22 is activated, If the sensor 23 exceeds the thresholds for inclination and triggers, the signal provided across the copper circuit 25 and 26 may change to alert the integrated circuit that the threshold value has been reached. The time adjustment selected through user interface 19 can comprise an adjustment portion 27 in a form of a series of resistors 28. These resistors have different resistance values and using the interface 19, the signal is passed to an appropriate resistor to achieve the time delay function required. The variation of electrical resistance may vary the time delay before activation of the buzzer 18 through suitable means connected to the control board 24. Different electrical resistances may vary the time of conveying electrical pulse to a relevant processor resulting in time delay of the signal to the buzzer 18. Of course, numerous other means for providing a time delay function can be incorporated with te means merely required to sense that the inputs through copper or other circuits 25 and 26 have been maintained for the predetermined period of time once the sensor has been activated.

In use, the driving aid 1 may be fitted on the ear of a user or to the users glasses. An instinctive response upon becoming drowsy is the tendency of one's head to drop with the chin rotating towards the chest and causing angular displacement of one's head. This device when fitted to the users head may detect the degree of angular displacement and activate the buzzer or other indicator to alert the user or revive the driver once drowsy.

The level of sensitivity of the device can be adjusted in the preferred form by adjusting the angle at which the alarm may activate. This allows a user to adjust the angular displacement according to one's personal needs. Furthermore, a time delay circuit can be built in to adjust the length of time required to activate the alarm. This may reduce the alarm triggers from such momentary angular displacements of the head that may be necessary to control the vehicle.

Aside from alerting the driver when becoming drowsy, the device may also assist in those circumstances where the driver is merely distracted from the roadway and that distraction continues longer than the driver anticipated. A driver may be distracted from the roadway to make such an adjustment and, upon having some difficulty, continue to make the adjustment without realising that the vehicle may be approaching danger. This driving aid may sound the buzzer to warn the driver that their attention has been away from the roadway ahead for a considerable length of time. This is in addition to the device's ability to detect similar displacement of the head upon the driver fallen asleep.

Thus it can be seen that the device provides a driving aid to alert the driver when angular displacement of the head exceeds a predetermined level for a predetermined period of time. The level of angular displacement and the period of time at which the displacement may be held can be adjustable.

Although the invention has been described with reference to particular embodiments, it will be appreciated that the invention should not be limited to those embodiments with the scope of the invention being defined by the appended claims. Items mentioned in the singular can include the plural where appropriate and deemed equivalents of any particular item are to be considered as incorporated as specifically set forth herein.

1. A driving aid comprising:
a movable portion movable between a first position and, upon inclination over a preset angle from the horizontal, to a second position;
means to detect the movement of said movable object to said second position;
means to alert a user when said movable object is in said second position for at least a preset time interval; and
means to fit said driving aid to the head of a user.

2. A driving aid as claimed in claim 1 wherein said means to detect the movement of said movable object comprises a photo sensor which senses said movable object in said second position.

3. A driving aid as claimed in claim 1 wherein said movable portion comprises a substantially spherical object movable on a base portion, guide or track between said first and second positions.

4. A driving aid as claimed in claim 3 wherein said base portion, guide or track contains an incline towards said second position when orientated for use.

5. A driving aid as claimed in claim 4 wherein said inclination of said base portion, guide or track is adjustable to adjust the level of inclination of the device.

6. A driving aid as claimed in claim 4 wherein said base portion, guide or track comprises a tubular portion.

7. A driving aid as claimed in claim 1 wherein said preset time interval is adjustable.

8. A driving aid as claimed in claim 1 wherein said means to alert a user comprises an audible alarm.

9. A driving aid as claimed in claim 1 wherein said means to fit said driving aid to the head of a user comprises means to fit said device on or about the ear of a user.

10. A driving aid as claimed in claim 1 wherein said means to fit said driving aid to the head of a user comprises attachment means to attach said device to the arm of a pair of glasses.

11. A driving aid as claimed in claim 1 wherein said means to fit said driving aid to the head of a user comprises both a first means to attach the device on or about the ear of a user and a second alternative attachment means for attachment of said driving aid to the arm of a pair of glasses.
